(19) United States
(12) Patent Application Publication
(10) Pub. No.: US 2025/0019621 A1
(43) Pub. Date: Jan. 16, 2025

(54) AQUEOUS FABRIC CONDITIONER COMPOSITIONS WITH HIGH PERFORMANCE FRAGRANCES

(71) Applicant: INTERNATIONAL FLAVORS & FRAGRANCES INC., NEW YORK, NY (US)

(72) Inventors: Caroline Celine Rose Girod, Hilversum (NL); Robert Allan Hunter, Hilversum (NL); Dennis Lensen, Hilversum (NL); Stephen Nicoll, Summit, NJ (US); Franc T. Schiet, Naarden (NL); Arrisje Clasina Van Eck, Hilversum (NL)

(21) Appl. No.: 18/712,897

(22) PCT Filed: Nov. 30, 2022
(86) PCT No.: PCT/US2022/051382

§ 371 Date: May 23, 2024

Related U.S. Application Data
(60) Provisional application No. 63/285,644, filed on Dec. 3, 2021.

(51) Int. Cl. C11D 3/50; C11D 3/00; C11D 3/30

(52) U.S. Cl. CPC C11D 3/505; C11D 3/001; C11D 3/30

(57) ABSTRACT

This disclosure relates to an aqueous fabric conditioner composition containing: (i) a fragrance component present in an amount of ≤1 wt % relative to the total weight of the composition, wherein the fragrance component comprises at least one, at least two, at least three, at least four, at least five, at least six, at least seven, at least eight, at least nine or at least ten High Performance fragrance ingredients selected from the group consisting of Ultra High-Impact fragrance ingredients as listed in Table 1 and High-Impact fragrance ingredients as listed in Table 2; and (ii) a fabric conditioner active. The composition exhibits parity and/or improved visco-stability and/or perceived intensity, perceived longevity and/or perceived fidelity of a fragrance profile, particularly fresh and clean characters. This disclosure also relates to use of the aqueous fabric conditioner composition for imparting or enhancing the perception of the fragrance profile on fabrics.

### FIELD OF THE INVENTION

The present invention relates to fabric conditioner compositions, more specifically aqueous fabric conditioner compositions, comprising High Performance fragrance ingredients to enable lower dosing of the fragrances with enhanced performance, parity/improved fragrance profile benefits and/or extended shelf-life aesthetics. The invention also relates to methods of making and/or using said compositions.

### BACKGROUND OF THE INVENTION

Fragrance materials are added to fabric conditioners to enhance the consumers' enjoyment of the products. Unfortunately, the addition of fragrance materials (neat or encapsulated) into a fabric conditioner base may cause chemical and/or physical disruptions to various parameters of the system. Specifically, the addition of fragrances can have an effect on the visco-stability of the fabric conditioner, particularly noticeable over the life-time of the product. For example, the viscosity of the product may increase over time and negatively impact its aesthetics (e.g., flowability/pourability, color, turbidity, etc.). To overcome this issue, fragrances can be dosed at reduced levels (e.g., half to one-tenth of normal dosages).

There are several drawbacks to this approach. Firstly, the perceived intensity of a fragrance profile is reduced. Secondly, the longevity of the fragrance profile is also reduced. This is a problem because there are so many “touch points” with consumers associated during the laundry experience. Non-limiting examples of such touch points include the freshness or clean experience associated with opening a fabric conditioner container, damp clothes upon opening a washing machine after washing laundry, opening a laundry dryer after drying laundry, drying clothes on drying frame and freshness or clean associated with wearing laundered clothes (e.g., one day or one week after laundered laundry). The fragrances in the fabric conditioner needs to delight the consumer during all or most of these touch points, so as to provide a delightful experience. Thirdly, the overall fragrance profile will change over time. This is a problem because it is desirable to maintain the ‘signature character’ (e.g., fresh or clean scent) of the product consistently throughout its use. In other words, it is desirable to maintain the same or substantively similar fragrance profile at the various “touch points” as described above. Lastly, it is generally accepted that consumers desire prolonged intensity of select characters (e.g., fresh and clean) derived from the top notes and heart notes. However, the consequence of reducing the fragrance levels is that you will lose these desirable characters, and particularly lose the ability to extend these desirable characters over long periods of time.

The Applicant is not aware of any previous attempts to overcome these specific problems. U.S. patent application Ser. No. 17/340,132, the disclosure of which is incorporated in full by reference herein, discloses consumer products composed of High-Performance fragrance ingredients. In particular, the High-Performance fragrance ingredients are used at reduced levels (≤1%) for improved aesthetics (e.g., clarity and viscosity, reduce discoloration) in a range of consumer products (e.g., an antiperspirant, a deodorant, a scent booster and a candle). However, there is no mention of the problems outlined above, nor any solutions to overcome them. Thus, the unique challenge remains of reducing the levels of fragrances in fabric conditioner to mitigate the performance and visco-stability issues while still delivering on fragrance profile associated with laundered laundry to delight consumers.

Additionally, many of the fragrance ingredients that are used in fabric conditioner compositions today are produced from non-renewable petroleum feedstock. There remains a need to formulate fabric conditioner compositions with fragrances that are substantially made from renewable resources, as well as provide acceptable fragrance profile performance.

### SUMMARY OF THE INVENTION

The invention is based, inter alia, on the discovery that High Performance fragrance ingredients composed of certain Ultra High-Impact fragrance ingredients and High-Impact fragrance ingredients can be formulated at reduced levels (e.g., up to 10 times less than standard fragrances) into aqueous fabric conditioners to deliver improved perceived intensity, perceived longevity and/or perceived fidelity of the fragrance profile at the various “touch points” associated with the laundry experience. Furthermore, the reduced levels of the High Performance fragrance ingredients cause less interruptions to the fabric conditioner systems, thereby minimizing any negative impact on the chemical/physical parameters and/or performance of the systems.

Thus, according to a first aspect, the present invention is directed to an aqueous fabric conditioner composition comprising: (i) a fragrance component present in an amount of ≤1 wt % relative to the total weight of the composition; and (ii) a fabric conditioner active. The fragrance component comprises at least one, at least two, at least three, at least four, at least five, at least six, at least seven, at least eight, at least nine or at least ten High Performance fragrance ingredients selected from the group consisting of Ultra High-Impact fragrance ingredients as listed in Table 1 and High-Impact fragrance ingredients as listed in Table 2.

In another aspect, the present invention is directed to use of an aqueous fabric conditioner composition of the present invention for imparting or enhancing the perception of a fragrance profile, in particular a fresh character and/or a clean character, by a consumer during use.

Thus, it is an advantage of the present invention to provide new design guidelines for formulating with fragrance materials intended for use with fabric conditioners. In particular, the design guidelines identify select Ultra High-Impact and High-Impact fragrance ingredients as set out in Tables 1 and 2, respectively, intended to be used at lower dose (up to 2, 5 or 10 times lower) than a standard fragrance, without observing a corresponding reduction in performance of fragrance profile.

It is a further advantage of the present invention to provide aqueous fabric conditioner compositions having improved intensity to the perceived fragrance profile over time. It is yet a further advantage to provide aqueous fabric conditioner compositions wherein the perceived fragrance profile, preferably the fresh and/or clean characters attributable to top notes and/or heart notes, remains significantly consistent across the different touch points during the laundry experience. It is yet a further advantage to provide aqueous fabric conditioner compositions having improved longevity of the perceived fragrance profile, preferably the fresh and/or clean characters attributable to top notes and/or heart notes, over time. It is yet a further advantage to provide aqueous fabric conditioner compositions having stable quality of end product (e.g., aesthetics, fragrance profile, etc.), preferably even after one month, two months or three months storage at 40° C. It is yet a further advantage to be able to create new fragrance profiles.

All parts, percentages and proportions referred to herein and in the claims are by weight unless otherwise indicated.

The values and dimensions disclosed herein are not to be understood as being strictly limited to the exact numerical values recited. Instead, unless otherwise specified, each such value is intended to mean both the recited value and a functionally equivalent range surrounding that value. For example, a value disclosed as “50%” is intended to mean “about 50%” or alternatively, for example, about ±2%, ±5%, ±10% or ±15% of that value.

The details of one or more aspects of the invention are set forth in the description below. Other features, objects, and advantages of the invention will be apparent to those skilled in the art from the detailed description and the drawing.

### BRIEF DESCRIPTION OF THE DRAWING

While the specification concludes with claims particularly pointing out and distinctly claiming the invention, it is believed that the invention will be better understood from the following description of the accompanying figures wherein:

FIG. 1 shows a graph of the viscosity measurement results of three encapsulated fragrance compositions in fabric conditioner base at 19% active level and measured over a 20-week time period at 37° C. according to Example 2a.

FIG. 2 shows a graph of the sensory evaluation results of perceived fragrance profile of three encapsulated fragrance compositions in fabric conditioner base at 19% active level at dry pre and dry gentle handling stages according to Example 2b.

FIG. 3 shows a graph of the sensory evaluation for High Performance Fragrance Examples 3 and 4 compared to Benchmark Fragrance Examples 1 and 2 at different fabric conditioner active levels (2% and 19%) according to Example 4.

### DETAILED DESCRIPTION OF THE INVENTION

### Definitions

As used herein, articles such as “a” and “an” when used in a claim, are understood to mean one or more of what is claimed or described.

As used herein, the term “biobased” refers to atoms or molecules obtained from biomass, e.g., obtained from materials containing organic carbon of renewable origin. Sources of such carbon can be derived from agricultural products, plants, animals, fungi, microorganisms, marine, or forestry materials.

The term “biodegradable” or “biodegradability” as used herein with respect to a material, such as microcapsule shell and/or fragrance ingredients, has no real or perceived health and/or environmental issues, and can undergo and/or does undergo physical, chemical, thermal, microbial and/or biological degradation. Ideally, a microcapsule shell and/or fragrance is deemed “biodegradable” when the microcapsule shell and/or fragrance has a biodegradability measured according to Organization for Economic Cooperation and Development (OECD) tests, including OECD301F test (O2 consumption), OECD310 test (Ready biodegradation), OECD302 test (inherent biodegradation), OECD307 test (soil stimulation studies), OECD308 test (sediment stimulation studies), or OECD309 test (water stimulation studies), or the International Organization for Standardization (ISO) tests including, ISO 17556 test (solid stimulation studies), ISO 14851 test (fresh water stimulation studies), or ISO 18830 test (marine sediment stimulation studies).

In some aspects, microcapsule wall or fragrance ingredients having biodegradability measured according to OECD 301F of at least 20% or 40% is considered to be “inherently biodegradable”, “inherently primary biodegradable” or “biodegradable”. “Inherently biodegradable” refers to a classification of chemicals for which there is unequivocal evidence of biodegradation in any tests of biodegradability. “Primary biodegradation” refers to the alteration in the chemical structure of a substance, brought about by biological action, resulting in the loss of a specific property of that substance. In other aspects, microcapsule wall or fragrance ingredients having biodegradability measured according to OECD 301F of at least 60%, particularly after 60 days, is considered to have “ultimate biodegradability”. “Ultimate biodegradation” refers to the level of degradation achieved when the test compound is totally utilized by micro-organisms resulting in the production of carbon dioxide, water, mineral salts and new micro cellular constituents (biomass). These characterizations of biodegradability correspond to the limit values set out in the “Revised Introduction to the OECD Guidelines for Testing of Chemicals”, Section 3, Part 1, dated 23 Mar. 2006.

As used herein, the term “consumer” means both the user of the composition and the observer nearby or around the user.

The terms “fragrance component” and “fragrance composition” are used interchangeably, and refers to a composition of fragrance materials for the purpose of delivering a specific and/or pleasant fragrance profile to drive consumer delight or acceptance of the aqueous fabric conditioner composition.

As used herein, the terms “fragrance material(s)”, and “fragrance ingredient(s)” are used interchangeably and relate to a perfume raw material (“PRM”), or a mixture of perfume raw materials (“PRMs”), that are used to impart an overall pleasant odor or fragrance profile to a composition. “Fragrance materials” can encompass any suitable perfume raw materials for fragrance uses, including materials such as, for example, alcohols, aldehydes, ketones, esters, ethers, acetates, nitriles, terpene hydrocarbons, nitrogenous or sulfurous heterocyclic compounds and essential oils. However, naturally occurring plant and animal oils and exudates comprising complex mixtures of various chemical components are also known for use as “fragrance materials”. The individual perfume raw materials which comprise a known natural oil can be found by reference to Journals commonly used by those skilled in the art such as “Perfume and Flavourist” or “Journal of Essential Oil Research”, or listed in reference texts such as the book by S. Arctander, Perfume and Flavor Chemicals, 1969, Montclair, New Jersey, USA and more recently re-published by Allured Publishing Corporation Illinois (1994). Additionally, some perfume raw materials are supplied by the fragrance houses (Firmenich, International Flavors & Fragrances, Givaudan, Symrise) as mixtures in the form of proprietary specialty accords. Non-limiting examples of the fragrance materials useful herein include pro-fragrances such as acetal pro-fragrances, ketal pro-fragrances, ester pro-fragrances, hydrolyzable inorganic-organic pro-fragrances, and mixtures thereof. The fragrance materials may be released from the pro-fragrances in a number of ways. For example, the fragrance may be released as a result of simple hydrolysis, or by a shift in an equilibrium reaction, or by a pH-change, or by enzymatic release.

As used herein, the term “fragrance profile” means the description of how the fragrance is perceived by the human nose at any moment in time. The fragrance profile may change over time. It is a result of the combination of the base, heart and top notes, if present, of a fragrance. Base notes are characterized by providing animalic, woody, sweet, amber or musky characters, and not being very volatile. Heart notes are associated with desirable characters such as floral characters (e.g., jasmin, rose), fruity, marine, aromatic or spicy characters. The “top or head notes” provide citrusy, green, light, or fresh characters and tend to evaporate quickly due to their high volatility. A fragrance profile is composed of 2 characteristics: ‘intensity’ and ‘character’. The ‘intensity’ relates to the perceived strength whilst ‘character’ refers to the odor impression or quality of the perfume, i.e., fresh, clean, etc.

As used herein, the terms “g,” “mg,” and “g” refer to “gram,” “milligram,” and “microgram,” respectively. The terms “L” and “mL” refer to “liter” and “milliliter,” respectively.

As used herein, the terms “include”, “includes” and “including” are meant to be non-limiting.

It is understood that the test methods that are disclosed in the Test Methods Section of the present application must be used to determine the respective values of the parameters of Applicants' inventions as described and claimed herein.

### Aqueous Fabric Conditioner Compositions

It has been surprisingly discovered that fragrance compositions that adhere to a set of design guidelines for the inclusion of certain types of Ultra High-Impact and High-Impact fragrance ingredients, results in High Performance fragrance ingredients for use in aqueous fabric conditioner composition that improves fragrance profile and/or aesthetic properties of the system.

In certain aspects, the fragrance composition is composed of at least one, at least two, at least three, at least four, at least five, at least six, at least seven, at least eight, at least nine, at least ten, at least fifteen, at least twenty, at least twenty-five, at least thirty, at least thirty-five or at least forty High Performance fragrance ingredients. More specifically, the High Performance fragrance ingredients include Ultra High-Impact fragrance ingredients and High-Impact fragrance ingredients. For the purposes of this invention, Ultra High-Impact fragrance ingredients of use either alone or in combination in the fragrance component are selected from the fragrance ingredients listed in Table 1. In some embodiments, the fragrance component may include 1, 2, 3, 4, 5, 6, 7, 8, 9, 10, 15, 20, 25, 30, 35, 40 or more Ultra High-Impact fragrance ingredients as listed in Table 1.

TABLE 1
Ultra High-Impact Fragrance Ingredients

| No. | Trade Name | CAS |
|---|---|---|
| 1. | ALD C-11 INTRELEVEN (TT) PRG | 143-14-6 |
| 2. | ALD C-6 TOCO | 66-25-1 |
| 3. | Musk Indenofuran (2,2,6,6,7,8,8- | 476332-65-7 |
| | heptamethyldecahydro-2H-indeno[4,5-b]furan) | 647828-16-8 |
| 4. | AMBERMOR EX | 6790-58-5 |
| 5. | AMBERMORKETAL | 57345-19-4 |
| 6. | AMBROCENIDE CRYST | 211299-54-6 |
| 7. | CALONE | 28940-11-6 |
| 8. | CITRYLAL BHT | 90480-35-6 |
| | | 147060-73-9 |
| 9. | CLONAL | 2437-25-4 |
| 10. | CREOSOL #340 | 93-51-6 |
| 11. | CRESYL ACET PARA COEUR | 140-39-6 |
| 12. | DECENAL,CIS-4 | 21662-09-9 |
| 13. | DODECENAL TRANS-2 TOCO | 20407-84-5 |
| 14. | DUPICAL TOCO | 30168-23-1 |
| 15. | DYNASCONE BHT | 56973-85-4 |
| 16. | FLORAL SUPER | 71077-31-1 |
| 17. | FRAGARONE | 16957-70-3 |
| 18. | GALBASCONE ALPHA 95 PRG | 56973-85-4 |
| 19. | GALBASCONE PRG TOCO | 56973-85-4 |
| | | 56973-84-3 |
| 20. | ISO BUTYL QUINOLINE | 67634-06-4 |
| 21. | ISO BUTYL THIAZOLE | 18640-74-9 |
| 22. | JAMUNATE | 7605-52-9 |
| 23. | KOUMALACTONE 10 PCT TEC FIRM | 77-93-0 |
| 24. | MANGONE CSM | 38462-22-5 |
| 25. | MELOZONE | 30772-79-3 |
| 26. | METH HEPTIN CARBONATE | 111-12-6 |
| 27. | METH LAITONE 10 PCT DPG | 110-98-5 |
| 28. | METH PHEN ETH ETHER | 3558-60-9 |
| 29. | NONADIENAL,2-TR-6-CIS TOCO | 557-48-2 |
| 30. | NONENOL,CIS-6 TOCO | 35854-86-5 |
| 31. | OPALENE TOCO | 174155-47-6 |
| 32. | ORENYLE | 29127-83-1 |
| 33. | ORRIS ALD TOCO | 60784-31-8 |
| 34. | OXANE 50 PCT TEC | 59323-76-1 |
| | | 59324-17-3 |
| 35. | PASSION FRUIT CMPD | 59323-76-1 |
| 36. | PHARAONE 10 PCT DPG | 110-98-5 |
| 37. | PYRAZINE 044 (METH) | 109-08-0 |
| 38. | ROSE OXIDE “L” TOCO | 16409-43-1 |
| 39. | ROSYRANE SUPER | 60335-71-9 |
| 40. | SACRAZOLE-018 | 137-00-8 |
| 41. | THIAZOLE (2-ISO PROP 4-METH) | 15679-13-7 |
| 42. | TRIDECENE-2-NITRILE | 22629-49-8 |
| 43. | TROPICALIA TOCO | 10138-32-6 |
| 44. | VIONIL NEAT | 67019-89-0 |
| 45. | HEALINGWOOD ¹ | Natural Oil |
| 46. | VIOLET LEAF ABS EGYPT LMR ¹ | Natural Oil |

¹ Available from International Flavors & Fragrances Inc.

For the purposes of this invention, High-Impact fragrance ingredients of use either alone or in combination in the fragrance component are selected from the fragrance ingredients listed in Table 2. In some embodiments, the fragrance component may include 1, 2, 3, 4, 5, 6, 7, 8, 9, 10, 15, 20, 25, 30, 35, 40 or more High-Impact fragrance ingredients as listed in Table 2.

TABLE 2
High-Impact Fragrance Ingredients

| No. | Trade Name | CAS |
|---|---|---|
| 1. | ACETOPHENONE | 98-86-2 |
| 2. | AGRUNITRILE | 51566-62-2 |
| 3. | ALD AA TRIPLAL BHT | 68039-49-6 |
| 4. | ALD C-10 | 112-31-2 |
| 5. | ALD C-11 MOA BHT | 19009-56-4 |
| 6. | ALD C-11 ULENIC TOCO | 112-45-8 |
| 7. | ALD C-11 UNDECYLIC TOCO | 112-44-7 |
| 8. | ALD C-12 LAURIC TOCO | 112-54-9 |
| 9. | ALD C-12 MNA TOCO | 110-41-8 |
| 10. | ALD C-16 STRAWB#2 | 77-83-8 |
| 11. | ALD C-18 | 104-61-0 |
| 12. | ALD C-8 TOCO | 124-13-0 |
| 13. | ALD C-9 TOCO | 124-19-6 |
| 14. | AMBERTONIC | 1392325-86-8 |
| 15. | AMBRETTOLIDE | 28645-51-4 |
| 16. | AQUAFLORA TOCO | 1339119-15-1 |
| 17. | BENZALD FFC | 100-52-7 |
| 18. | CASHMERAN | 33704-61-9 |
| 19. | CEDRAMBER | 67874-81-1 |
| 20. | CITRAL NEW | 5392-40-5 |
| 21. | COOLWOOD | 1340502-69-3 |
| 22. | CRESOL PARA EXTRA | 106-44-5 |
| 23. | CRISTALFIZZ | 1093653-57-6 |
| 24. | CYCLAPROP | 68912-13-0 |
| 25. | CYCLEMAX | 7775-00-0 |
| 26. | DAMASCENONE TOCO | 23696-85-7 |
| 27. | DAMASCONE DELTA | 71048-82-3 |
| 28. | DELPHONE | 4819-67-4 |
| 29. | DIPHEN OXIDE | 101-84-8 |
| 30. | DORIFFOX | 149713-23-5 |
| 31. | ETH ACETO ACET | 141-97-9 |
| 32. | ETH CAPROATE | 123-66-0 |
| 33. | ETH PHEN GLYC | 121-39-1 |
| 34. | ETH SAL | 118-61-6 |
| 35. | ETH-2-METH BUTY | 7452-79-1 |
| 36. | EUCALYPTOL USP | 470-82-6 |
| 37. | FLORHYDRAL TOCO (ELINCS) | 125109-85-5 |
| 38. | FRUITATE (ELINCS) | 129520-41-8 |
| 39. | HEXADECANOLIDE BHT | 109-29-5 |
| 40. | HEXENYL ISOBUTY,CIS-3 | 41519-23-7 |
| | (VERDURAL B) | |
| 41. | INDOLE | 120-72-9 |
| 42. | IONONE ALPHA TOCO | 127-41-3 |
| 43. | IRONE V BHT | 79-69-6 |
| 44. | ISO CYCLO CITRAL TOCO | 1423-46-7 |
| 45. | LACTONE OF CIS JASMONE TOCO | 70851-61-5 |
| 46. | LEMONILE | 61792-11-8 |
| 47. | MELONAL TOCO | 106-72-9 |
| 48. | MENTHONE 85 | 89-80-5 |
| 49. | METH BENZOATE | 93-58-3 |
| 50. | METH CINNAMATE TOCO | 103-26-4 |
| 51. | METH DH JASMONATE | 24851-98-7 |
| 52. | METH HEPTYL KETONE | 821-55-6 |
| 53. | METH JASMONATE TOCO | 39924-52-2 |
| 54. | METH OCTIN CARBONATE | 111-80-8 |
| 55. | METH PARA CRESOL | 104-93-8 |
| 56. | METH TUBERATE RD | 35205-76-6 |
| 57. | MUSCEMOR (ELINCS) | 82356-51-2 |
| 58. | MYRAC ALD BHT | 52475-89-5 |
| 59. | NECTARYL LRG 1371 ELINCS | 95962-14-4 |
| 60. | OCEANOL | 33662-58-7 |
| 61. | OPERANIDE (ELINCS) | 823178-41-2 |
| 62. | PHEN ETH ACET | 103-45-7 |
| 63. | PINEAPPLE CMPD | 3658-77-3 |
| 64. | PINO ACETALD TOCO | 33885-51-7 |
| 65. | ROSALVA | 13019-22-2 |
| 66. | ROSE OXIDE TOCO | 16409-43-1 |
| 67. | ROSETHYL | 64988-06-3 |
| 68. | SAFRALEINE | 54440-17-4 |
| 69. | SINFONIDE | 1315251-11-6 |
| 70. | STARFLEUR TOCO | 1254940-85-6 |
| 71. | SYLVONIC | 98-55-5 |
| 72. | TERPINOLENE P UB BHT | 586-62-9 |
| 73. | TOFFEE LACTONE 2067 | 705-86-2 |
| | | 706-14-9 |
| 74. | TOFFEETONE FOR NON TSCA USE | 13537-82-1 |
| | ONLY | |
| 75. | TONKALACTONE | 54491-17-7 |
| 76. | TRIFERNAL BHT | 16251-77-7 |
| 77. | ULTRAVANIL Q COLIPA | 2563-07-7 |
| 78. | UNDECALACTONE, DELTA | 710-04-3 |
| 79. | UNDECAVERTOL TOCO | 81782-77-6 |
| 80. | VANITROPE | 94-86-0 |
| 81. | VARAMOL-106 | 7786-61-0 |
| 82. | VELTOL PLUS | 4940-11-8 |
| 83. | VERAMOSS | 4707-47-5 |
| 84. | VERIDIAN | 811412-48-3 |
| 85. | VERTOLIFF TOCO | 36635-35-5 |
| 86. | VERTONIC | 1945993-03-2 |
| 87. | VETIVER ACET HAITI TOCO BLO | 84082-84-8 |
| 88. | YARA YARA | 93-04-9 |
| 89. | YLANGANATE | 89-71-4 |
| 90. | ARMOISE OIL PURE ¹ | Natural oil |
| 91. | BLKCURRANT BUD ABS BURGUNDY | Natural oil |
| | LMR FOR LIFE ¹ | |
| 92. | CHAMOMILE OIL ENG ³ | Natural oil |
| 93. | CHAMOMILE OIL ROMAN LMR SFO ¹ | Natural oil |
| 94. | CINNAMON BARK ESSENTIAL LMR ¹ | Natural oil |
| 95. | DAVANA OIL LMR FLG SFO ¹ | Natural oil |
| 96. | EUGENOL NAT EX CLOVE LEAF OIL | Natural oil |
| 97. | JASMIN ABS EGYPT LMR ¹ | Natural oil |
| 98. | ORANGE FLOWER WATER ABS | Natural oil |
| | TUNISIA LMR ¹ | |
| 99. | OSMANTHUS ABS LMR ¹ | Natural oil |
| 100. | PATCHOULI OIL LIGHT BLO ² | Natural oil |
| 101. | PEPPER PINK CO2 LMR ¹ | Natural oil |
| 102. | ROSE ABS DAMASCENA PURE BLO ¹ | Natural oil |
| 103. | SINENSAL NATURAL 20 EX ORANGE ³ | Natural oil |
| 104. | THYME OIL WHITE SPAIN BLO ¹ | Natural oil |

¹ Available from International Flavors & Fragrances Inc (New York).
² Available from TRIPPER PTE Ltd. (Indonesia).
³ Available from TREATT & CO. Ltd. (United Kingdom).

In addition to the fragrance materials listed in Tables 1 and 2, the fragrance component may include at least one additional fragrance ingredients. Preferably, the fragrance component may include 1, 2, 3, 4, 5, 6, 7, 8, 9, 10, 15, 20, 25, 30, 35, 40 or more additional fragrance ingredients, which are not listed in Tables 1 and 2. Non-limiting examples of such additional fragrance ingredients include those described in US 2018/0325786 A1, U.S. Pat. Nos. 4,534,891, 5,112,688, and 5,145,842.

The additional fragrance ingredients, when combined with one or more fragrance ingredients of Tables 1 and 2, constitute the total fragrance composition. In this respect, the balance of the 100 wt % relative to the total weight of the fragrance component is made up of one or more Ultra High-Impact and High-Impact fragrance ingredients of Tables 1 and 2 and one or more additional fragrance ingredients.

When including a combination of the Ultra High-Impact fragrance ingredients and the High-Impact fragrance ingredients listed in Tables 1 and 2, at the specified amounts, the fragrance composition can be used in an aqueous fabric conditioner product at a significantly reduced dosage (e.g., at least 2-, 5- to 10-fold lower levels) as compared to a standard fragrance that does not include the Ultra High-Impact fragrance ingredients and High-Impact fragrance ingredients listed in Tables 1 and 2, at the specified amounts. In particular, the fragrance component of this invention can be used at a dosage level of ≤1 wt % relative to the total weight of the composition without significantly impacting the fragrance profile, i.e., perceived fragrance intensity, perceived fragrance longevity and/or perceived fragrance fidelity, particularly for select characters (e.g., fresh and/or clean). Additionally, the fragrance composition of this invention improves one or more aesthetic properties of the product. Such aesthetics features include clarity, viscosity, color, flowability, and the like.

In some aspects, the fragrance component is used at a dosage level of less than or equal to 1 wt %, 0.99 wt %, 0.95 wt %, 0.9 wt %, 0.8 wt %, 0.7 wt %, 0.6 wt %, 0.5 wt %, 0.4 wt %, 0.3 wt %, 0.2 wt %, 0.1 wt %, 0.05 wt % or 0.01 wt % of the total weight of the aqueous fabric conditioner composition, or any range delimited by any pair of the foregoing values.

The aqueous fabric conditioner composition includes as fabric conditioner active, a fabric softening agent, a surfactant, bleach, enzyme, chelator, brightener and the like. Suitable fabric softener systems are described in U.S. Pat. Nos. 6,335,315; 5,674,832; 5,759,990; 5,877,145; 5,574,179; 5,562,849; 5,545,350; 5,545,340; 5,411,671; 5,403,499; 5,288,417; 4,767,547 and 4,424,134. Preferably, the fabric conditioner active is present in the amount of ≤25 wt % (e.g., 1 wt % to 20 wt %, 4 wt % to 10 wt %, or 8 wt % to 15 wt %) relative to the total weight of the composition. Preferably, the fabric conditioner active is present in the amount of from 0.01 wt % to 14 wt %, preferably from 0.01 wt % to 8 wt %, relative to the total weight of the composition. Preferably, the fabric conditioner active is a fabric softening agent. As an illustration, when the fabric softener is 5% by weight of the aqueous fabric conditioner composition, the fabric softening agent is 0.01% to 2.5%, preferably 0.02% to 1.25% and more preferably 0.1% to 0.63%. As another example, when the fabric softening agent is 20% by weight of the aqueous fabric conditioner composition, the fabric softening agent is 0.04% to 10%, preferably 0.08% to 5% and more preferably 0.4% to 2.5%. Suitable fabric softening agents include cationic surfactants. Non-limiting examples are quaternary ammonium compounds (QAC) such as alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, or a combination thereof. Preferably the fabric softening agent is selected from the group consisting of quaternary ammonium compound (QAC), non-ester quaternary ammonium compound, and mixtures thereof.

The preferred fabric softening agents are typically cationic and include water-insoluble quaternary-ammonium fabric softeners, the most commonly used having been di-long alkyl chain ammonium chloride or methyl sulfate. Preferred cationic softeners include but are not limited to rapidly biodegradable quaternary ammonium compounds which contain 1 or more ester bonds situated between the quaternary-ammonium group and the long alkyl chain (e.g., TEA ester quats, DEEDMAC, and HEQ). Preferred non-ester quaternary ammonium compounds include but are not limited to ditallow dimethylammonium chloride (DTDMAC), dihydrogenated tallow dimethylammonium chloride, dihydrogenated tallow dimethylammonium methylsulfate, distearyl dimethylammonium chloride, dioleyl dimethylammonium chloride, dipalmityl hydroxyethyl methylammonium chloride, stearyl benzyl dimethylammonium chloride, and tallow trimethylammonium chloride, hydrogenated tallow trimethylammonium chloride, C₁₂-C₁₄ alkyl hydroxyethyl dimethylammonium chloride, C₁₂-C₁₈ alkyl dihydroxyethyl methylammonium chloride, di(stearoyloxyethyl) dimethylammonium chloride (DSOEDMAC), di(tallowoyloxyethyl) dimethylammonium chloride, ditallow imidazolinium methylsulfate and 1-(2-tallowylamidoethyl)-2-tallowyl imidazolinium methylsulfate.

In further aspects, the invention also provides for aqueous fabric conditioner composition for imparting a fragrance profile, preferably for improving the fragrance profile, particularly enhancing the perceived intensity, perceived longevity and/or perceived fidelity of the fragrance profile by including in the fabric conditioner product a fragrance composition of this present invention. Advantageously, the fragrance composition of the present invention exhibits or enhances a perceived intensity, perceived longevity and/or perceived fidelity of a fragrance profile at 24 hours after use that is parity with or greater than a perceived intensity, perceived longevity and/or perceived fidelity of a control composition that does not contain the High Performance fragrance ingredients (i.e., a fragrance composition that does not include a fragrance listed in Tables 1-2, at the specified amounts), as determined by a panel method as disclosed herein.

The perceived performance of the fragrance composition of the present invention is attributable to the presence of Ultra High-Impact fragrance ingredients and High-Impact fragrance ingredients of Tables 1 and 2, respectively. For the purpose of this invention, “perceived performance” or “perceived fragrance performance” are used interchangeably to refer to the intensity, longevity and/or fidelity of a fragrance as perceived by a consumer. Preferably, the fragrance composition comprises the Ultra High-Impact fragrance ingredients selected from the group consisting of Table 1 ingredients 4, 16, 19, 39, 43 and mixtures thereof. Preferably, the fragrance composition comprises the High-Impact fragrance ingredients selected from the group consisting of Table 2 ingredients 3, 4, 6, 14-16, 20, 21, 23-27, 42, 46, 57, 61, 83, 88-89, 96 and mixtures thereof.

In further aspects, the present invention also provides an aqueous fabric conditioner composition, wherein the fabric conditioner active is present in the amount of from 0.01 wt % to 14 wt %, preferably 0.01 wt % to 8 wt %, relative to the total weight of the composition. The fragrance component, preferably the High Performance fragrance ingredients, more preferably the Ultra High-Impact fragrance ingredients, exhibit a perceived longevity of a fragrance profile, preferably the fragrance profile derived from top notes and heart notes, at 24 hours after use by a consumer that is parity with or greater than a perceived longevity of a control composition that does not contain the High Performance fragrance ingredients (i.e., a fragrance composition that does not include a fragrance listed in Tables 1-2, at the specified amounts), as determined by a panel method as disclosed herein.

For the purposes of this invention, the fragrance profile preferably has a fresh and/or clean character, and the expression “after use” refers to 24 hours after application of the fabric conditioner composition on the fabric. The perceived fragrance performance (i.e., intensity, longevity and/or fidelity) is typically assessed under different conditions by trained panelists that are capable of differentiating unambiguously the odor of a given fragrance composition under a first condition, for example on a substrate (i.e., fabric) wetted with said fabric conditioner product or under a second condition, for example after said fabric conditioner has been dried on the substrate. Fragrance performance is measured according to the test methods disclosed herein.

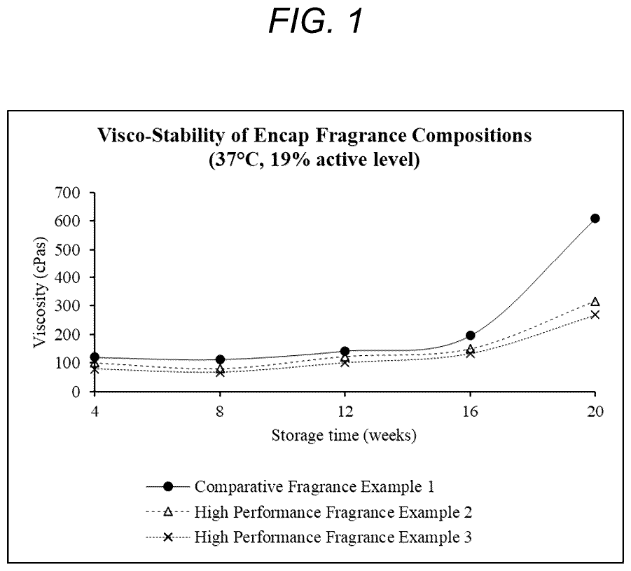

The present invention also provides for improved aesthetic characteristics of a scented fabric conditioner composition (e.g., clarity, viscosity, color, etc.) by including in the product a fragrance composition of the present invention at a level of ≤1 wt % relative to the total weight of the product. Preferably, the aqueous fabric conditioner composition of the present invention exhibits a stable viscosity of greater than 10 cps, preferably a viscosity in the range of from 20 cps to 200 cps as measured under shear 2 s⁻¹ at 25° C. In other words, the aqueous fabric conditioner composition of the present invention exhibits parity visco-stability performance compared to a control composition without the High Performance fragrance ingredients over short term storage. Preferably, the aqueous fabric conditioner composition of the present invention exhibits a stable viscosity in the range of from 20 cps to 350 cps as measured under shear 2 s⁻¹ at 37° C. That means that under accelerated stability testing, the aqueous fabric conditioner composition of the present invention exhibits parity visco-stability performance compared to a control composition without the High Performance fragrance ingredients over short term storage (see FIG. 1). Preferably the viscosity is maintained for a least a month, at least two months, at least three months or at least four months after storage at 37° C., preferably at 45° C. Viscosity is measured according to the test methods disclosed herein.

Another important aspect of the present invention is the desire to move towards the use of fragrance ingredients and/or microcapsules derived from “Green Chemistry” principles. Green Chemistry is focused on the design of products and processes that minimize environmental impact, particularly by using renewable feedstocks. In other words, the raw material or feedstock used to make the fragrance ingredients and/or microcapsules should be renewable rather than depleting whenever technically and economically practicable. Preferably, the fragrance component of the present invention has a bio-renewable carbon (BRC) content of at least 25 wt %, at least 30 wt %, at least 34 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt % or at least 95 wt % based on the weight of the fragrance component. As used herein, “BRC” refers to carbon that is part of the earth's natural environment and non-fossil-based carbon. BRC are naturally occurring renewable, repurposed and/or upcycled carbon resources that can be replenished to replace the portion depleted by usage and consumption, either through natural reproduction, or other recurring processes in a finite amount of time (such as within a human lifetime). BRC would exclude carbon that comes from virgin crude oil.

Biodegradability is also an important factor in assessing the environmental fate of chemicals. Biodegradation is the chemical dissolution of fragrance materials and/or microcapsules by bacteria, fungi or other biological means. Biodegradability is evaluated, for example, according to the OECD Method 301/310 or equivalent. The test samples may be classified as “inherently biodegradable”, “primary biodegradable” or “ultimate biodegradable” based on the results usually after 28 or 60 days (and as defined herein above). In some aspects, use of the fabric conditioner composition of the present invention results in a reduction, preferably a substantial reduction, of the weight of non-biodegradable materials collected from wash water per wash, as compared to a control composition that does not contain the High Performance fragrance ingredients. In other words, there is less non-biodegradable materials in absolute terms when using the fragrance composition of the present invention because it is dosed up to ⅕^{th} to 1/10^{th} less than a control fragrance composition.

### Neat Fragrances

A “neat fragrance” refers to a fragrance component that is free from extraneous matter and is unencapsulated and/or unbound from other compounds that would cause a delay in the release of the fragrance ingredients. In some aspects, the fragrance component is a neat fragrance. When the fragrance component is a neat fragrance, the fragrance component is present in the amount of 0.01 wt % to 1 wt %, relative to the total weight of the composition. According to this aspect, the weight ratio of the Ultra High-Impact fragrance ingredients of Table 1 to the High-Impact fragrance ingredients of Table 2 ranges from 1:0 to 1:19.

When a standard neat fragrance is dosed at least 2, 5 or 10 times less in a fabric conditioner product, one would expect to get 2, 5 or 10 times less performance and fragrance profile, respectively. However, because Ultra High-Impact fragrance ingredients and High-Impact fragrance ingredients are meant to be dosed up to 2, 5 or 10 times less than standard fragrance ingredients, no noticeable drop in performance or fragrance profile are generally observed with the fragrance component of this invention. Without wishing to be bound by theory, Applicant submits that fabric conditioner active not only acts as softener, but also serves as a deposition aid for neat fragrance oil introduced into the fabric conditioner products. Given that the fabric conditioner active levels differ between products, this can have a large effect on the amount of deposition aid available for the neat fragrance oil. Therefore, because the dosage requirements for Ultra High-Impact fragrance ingredients and High-Impact fragrance ingredients are up to 2, 5 or 10 times less than standard fragrance, not as much of the deposition aid is required to deliver parity or improved hedonics. In fact, Applicant has shown parity or improved hedonics using Ultra High-Impact fragrance ingredients and High-Impact fragrance ingredients in fabric conditioner compositions with active levels ranging from 2 wt % (low) to 19 wt % (high). This was a surprising discovery because it has been observed that lower active level bases with standard fragrances result in decreased hedonics performance.

According to this aspect of the present invention, the Ultra High-Impact fragrance ingredients are present in an amount of ≥5 wt %, ≥10 wt %, ≥15 wt %, ≥20 wt %, ≥25 wt %, 30 wt %, ≥35 wt %, ≥40 wt %, ≥45 wt %, ≥50 wt %, ≥55 wt %, ≥60 wt %, ≥65 wt %, ≥70 wt %, ≥75 wt %, ≥80 wt %, ≥85 wt %, ≥90 wt % or ≥95 wt %, preferably ≥5 wt %, ≥10 wt %, ≥15 wt % or ≥20 wt % relative to the total weight of the High Performance fragrance ingredients, and the High-Impact fragrance ingredients are present in an amount of ≤95 wt %, ≤90 wt %, ≤85 wt %, ≤80 wt %, ≤75 wt %, ≤70 wt %, ≤65 wt %, ≤60 wt %, ≤55 wt %, ≤50 wt %, ≤45 wt %, ≤40 wt %, ≤35 wt %, ≤30 wt %, ≤25 wt %, ≤20 wt %, ≤15 wt %, ≤10 wt % or ≤5 wt %, preferably ≤95 wt %, ≤90 wt %, ≤85 wt % or ≤80 wt %, relative to the total weight of the High Performance fragrance ingredients.

Preferably for neat fragrances, the weight ratio of (a) the High Performance fragrance ingredients to (b) the additional fragrance ingredients ranges from 3:1 to 19:1. According to this aspect of the present invention, (a) the High Performance fragrance ingredients are present in an amount of ≥75 wt %, ≥80 wt %, ≥85 wt %, ≥90 wt % or ≥95 wt % relative to the total weight of the fragrance component, and (b) the additional fragrance ingredients are present in an amount ≤25 wt %, ≤20 wt %, ≤15 wt %, ≤10 wt % or ≤5 wt % relative to the total weight of the fragrance component. In other aspect of the present invention, the fragrance component comprises the High Performance fragrance ingredients present in an amount of 100 wt % relative to the total weight of the fragrance component.

### Encapsulated Fragrances

An “encapsulated fragrance” refers to a fragrance accord which is encapsulated in microcapsule in order to stabilize the odor impression over a prolonged period. Microcapsules are used to deliver fragrances to a target area in a time-delayed or controlled manner. Preferably, the encapsulated fragrance has an average particle size from 1 and 100 microns, preferably from 1 to 50 microns or more preferably from 1 to 20 microns. The microcapsules may be prepared from natural materials like fungal chitosan (see WO 2016/185171A1), silk fibroin particles (see US 2015/0164117A1), and biomolecules used as emulsifiers in microcapsule preparation (see WO 2016/193435A1; WO 2017/102812A1; US 2018/0078468A1; WO 2018/019894A1; WO 2018/019896A1; and WO 2017/102812A1). Multilayered coacervate between gelatin and gum Arabic capsules may be used in the present invention (see U.S. Pat. No. 4,946,624; WO 2012/001604A1; US 2015/0250689A1; and WO 2018/002214A1). Protein microcapsules are also useful within the scope of the present invention (see US 2017/0189283A1). Preferably, environmentally friendly microcapsules where the shell has a biodegradability of at least 60% within 60 days according to OECD 301F are also within the scope of the present invention (see WO2021/122633A1).

The addition of microcapsules into a fabric conditioner composition causes disruptions to the system. This is particularly noticeable over time, as the capsules will have an effect on the visco-stability of the end products. In other words, overall product viscosity increases over time which impacts several visual aspects of the product including flowability/pourability, color, odor intensity, etc. By formulating with the encapsulated fragrance component of the present invention, lower dose of the fragrance slurry can be added to the fabric conditioner composition therefore causes less interruptions to the total product formula while maintaining parity or increased fragrance performance in sensory evaluation.

When the fragrance component is an encapsulated fragrance, the fragrance component is present in the amount of 0.01 wt % to 0.5 wt % relative to the total weight of the composition. When including encapsulated fragrances at these levels, the neat oil equivalent (NOE) in the aqueous fabric conditioner is 0.005 wt % to 0.15% wt %. According to this aspect, the weight ratio of the Ultra High-Impact fragrance ingredients of Table 1 to the High-Impact fragrance ingredients of Table 2 ranges from 1:0 to 1:19. In fact, when using encapsulated Ultra High-Impact fragrance ingredients and High-Impact fragrance ingredients, a lower dose can be used thereby minimizing interruptions to the total fabric conditioner product formula while maintaining parity or increased performance.

According to this aspect of the present invention, the Ultra High-Impact fragrance ingredients are present in an amount of ≥5 wt %, ≥10 wt %, ≥15 wt %, ≥20 wt %, ≥25 wt %, ≥30 wt %, ≥35 wt %, ≥40 wt %, ≥45 wt %, ≥50 wt %, ≥55 wt %, ≥65 wt %, ≥75 wt %, ≥85 wt % or ≥95 wt %, preferably ≥5 wt %, ≥10 wt %, ≥15 wt % or ≥20 wt %, relative to the total weight of the High Performance fragrance ingredients, and the High-Impact fragrance ingredients are present in an amount of ≤95 wt %, ≤90 wt %, ≤85 wt %, ≤80 wt %, ≤75 wt %, ≤70 wt %, ≤65 wt %, ≤60 wt %, ≤55 wt %, ≤50 wt %, ≤45 wt %, ≤35 wt %, ≤25 wt %, ≤15 wt % or ≤5 wt %, preferably ≤95 wt %, ≤90 wt %, ≤85 wt % or ≤80 wt %, relative to the total weight of the High Performance fragrance ingredients.

According to this aspect of the present invention, the fragrance component may further comprise (b) at least one additional fragrance ingredient. Preferably, the weight ratio of (a) the High Performance fragrance ingredients to (b) the additional fragrance ingredients ranges from 1.2:1 to 9:1. According to this aspect of the present invention, (a) the High Performance fragrance ingredients are present in an amount of ≥55 wt %, ≥60 wt %, ≥65 wt %, ≥70 wt %, ≥75 wt %, ≥80 wt %, ≥85 wt % or ≥90 wt % relative to the total weight of the fragrance component, and the additional fragrance ingredients are present in an amount ≤45 wt %, ≤40 wt %, ≤35 wt %, ≤30 wt %, ≤25 wt %, ≤20 wt %, ≤15 wt % or ≤10 wt % relative to the total weight of the fragrance component.

In other aspect of the present invention, the fragrance component comprises the High Performance fragrance ingredients present in an amount of 100 wt % relative to the total weight of the fragrance component. Accordingly, in certain aspects, the encapsulated fragrance is included in a fabric conditioner product having a pH of 2 to 4, preferably a pH of 2.5 to 3.5. In some aspects of the present invention, the fragrance component is an encapsulated fragrance useful in improving a clean or freshness impression to a fabric.

According to other aspects of the present invention, the fragrance component may also be well-suited for use as a mixture of neat and encapsulated fragrances in the fabric conditioner product.

The invention is described in greater detail by the below non-limiting examples. Without further elaboration, it is believed that one skilled in the art can, based on the description herein, utilize the present invention to its fullest extent. All publications cited herein are incorporated by reference in their entirety.

### Test Methods

The following assays set forth must be used in order that the invention described and claimed herein may be more fully understood.

### Test Method 1: Measurement of Sample Viscosity

The viscosity of samples can be measured using the rheometer (Anton Paar, MCR302) and measurements are taken at shear rates of 2/s, 20/s and 106/s (rotations per second). For the visco-stability, samples are stored at four temperatures: 5° C., room temperature, 37° C. and 40° C. Viscosity is measured initially (t=0 days) and then periodically at 4-week intervals.

### Test Method 2: Fragrance Performance Evaluation

For the sensory analysis, samples are washed using a Miele PW6065 front loader washing machine. Wash loads of 2.2 kg, including big towels, T-shirts, pillowcases, dish towels, and evaluation towels (cotton 30 cm×30 cm), are used. The laundry is washed at 40° C. for 60 minutes using 15.5 liters of water, with two 17-liter rinses. The cloths are first washed with Persil non-bio detergent (70 g) and then with the fabric conditioner dosed at 36 g. Cloths are line dried.

Panelists are pre-screened for common anosmias and ability to differentiate and rank between varying odor levels using standard screening tests. After they are selected, panelists are trained for using the scale and testing procedures. Fragrance intensity is evaluated using a Labeled Magnitude Scale (LMS) scale ranging from 0 to 100 (labeled with 0=no sensation, 1.3=barely detectable, 6.1=weak, 17.2=moderate, 33.1=strong, 53.3=very strong and 100=strongest imaginable; Barry G. Green, Gregory S. Shaffer & Magdalena M. Gilmore. Evaluating the Labeled Magnitude Scale for measuring sensations of taste and smell. Chemical Senses. Vol. 21, pp 323-334, 1996). Fragrance intensity is evaluated at multiple stages during the laundry experience, including Point of Purchase, Soak, Bloom, Out of the machine, Soak, Dry Pre (dry cloths prior to handling), Dry Gentle handling (tossing dry cloths in a basket) and Dry Post (rubbing dry cloths against each other).

Assessment of fragrances at the dry stages is used as a measure of perceived fragrance longevity (i.e., how long the fragrance hangs around on the cloth). Samples are assessed blind, in randomized order, and with replicates against a benchmark. Fragrance profile is evaluated using Descriptive Analysis or Check-All-That-Apply methodology, including descriptors such as Aldehydic, Ambery, Citrus, Floral, Fruity, Woody, etc. Assessing the fragrance profile at multiple stages during the laundry experience (stages as described above) can be used as a measure of fragrance perceived fidelity (i.e., the consistency of the fragrance profile over time). Samples are assessed blind, in randomized order, and with replicates against a benchmark.

Fragrance benefit evaluations (e.g. fresh & clean attributes) are conducted with a consumer panel (greater than 100 consumers). Consumers are asked to group 30 fragrances into 3-10 groups based on how the fragrances smell (i.e. grouping of fragrances perceived to be similar to each other). After the groups are created, the consumer is asked to describe the different groups in terms of their attributes or benefits (e.g. does the scent make you feel fresh, does the scent make you feel clean, etc.). The data is analyzed to identify relations between ingredients (and their amounts) in the fragrance formulations and the consumer benefits (fresh & clean) associated therewith. Consumer tests are generally performed with multiple consumer panels from different regions or countries in the world, which allows to distinguish between “world-wide” and “region- or country-specific” fresh & clean fragrance compositions.

### EXAMPLES

The following examples are provided to further illustrate the invention and are not to be construed as limitations of the invention, as many variations of the present invention are possible without departing from its spirit or scope.

### Example 1: Preparation of Encapsulated Fragrance Compositions

Comparative Fragrance Examples 1 and 2 are provided below in Tables 3 and 4 and represent examples of encapsulated standard fragrance compositions not intended to form the fragrance component of the present invention.

High Performance Fragrance Example 3 as provided below in Tables 3 and 4 is a non-limiting example of a formulation of fragrance composition comprising encapsulated High Performance fragrance ingredients according to the present invention.

The following fragrance formulations are made by mixing the listed ingredients in the listed proportions (ppt) in Table 4 at room temperature. The capsules used are all melamine formaldehyde capsules C50V2 (ScentQ; available from International Flavors & Fragrances Inc.). The encapsulation process is well-known in the art and disclosed, for example, in US20070138671A1, EP1797946, and EP1797947.

TABLE 3
Fragrance Compositions

| | | Ultra | | |
|---|---|---|---|---|
| | High | High- | High- | Bio- |
| | Performance | Impact | Impact | Renewable |
| | Fragrance | Fragrance | Fragrance | Carbon |
| | Ingredients | Ingredients | Ingredients | Content |
| Example | (wt %) | (wt %) | (wt %) | (wt %) |
| Comparative | 29 | 3 | 26 | 37 |
| Fragrance | | | | |
| Example 1 | | | | |
| High | 58 | 9 | 49 | 34 |
| Performance | | | | |
| Fragrance | | | | |
| Example 2 | | | | |
| High | 69 | 7 | 62 | 35 |
| Performance | | | | |
| Fragrance | | | | |
| Example 3 | | | | |

TABLE 4
Fragrance Compositions

| | | | High | High |
|---|---|---|---|---|
| | | Comparative | Performance | Performance |
| | | Fragrance | Fragrance | Fragrance |
| Ingredient Name | CAS Number | Example 1 | Example 2 | Example 3 |
| ADOXAL TOCO | 141-13-9 | 14.29 | 35.00 | 0.00 |
| ALD AA TRIPLAL TOCO | 68039-49-6 | 28.57 | 60.00 | 65.00 |
| ALD C-10 TOCO | 112-31-2 | 0.00 | 0.00 | 75.00 |
| ALD C-12 MNA TOCO | 110-41-8 | 0.00 | 0.00 | 120.00 |
| ALLYL AMYL | 67634-00-8 | 28.57 | 0.00 | 0.00 |
| GLYCOLATE BHT | | | | |
| AMBER XTREME TM | 476332-65-7, | 8.57 | 25.00 | 6.00 |
| | 647828-16-8 | | | |
| AMBERTONIC | 1392325-86-8 | 0.00 | 0.00 | 15.00 |
| CASHMERAN | 33704-61-9 | 0.00 | 0.00 | 45.00 |
| CYCLACET | 2500-83-6 | 285.71 | 75.00 | 0.00 |
| CYCLAPROP | 68912-13-0 | 142.86 | 184.50 | 0.00 |
| CYCLOHEXYL SAL | 25485-88-5 | 0.00 | 0.00 | 21.00 |
| (ELINCS) | | | | |
| DAMASCONE DELTA | 71048-82-3 | 0.00 | 0.00 | 50.00 |
| TOCO | | | | |
| DIHYDRO TERPINEOL | 498-81-7 | 4.06 | 0.00 | 0.00 |
| DIHYDRO TERPINYL | 58985-18-5 | 94.29 | 0.00 | 0.00 |
| ACET | | | | |
| EUCALYPTOL USP CSM | 470-82-6 | 0.00 | 0.00 | 100.00 |
| FRUCTALATE (ELINCS) | 72903-27-6 | 0.00 | 0.00 | 25.00 |
| GALBANUM OIL LMR ¹ | natural oil | 0.00 | 0.40 | 0.50 |
| GALBASCONE ALPHA 95 | 56973-85-4 | 0.00 | 10.00 | 4.00 |
| PRG TOCO | | | | |
| GALBASCONE PRG | 56973-85-4, | 22.86 | 50.00 | 15.00 |
| TOCO | 56973-84-3 | | | |
| GERANIOL 980 PURE | 106-24-1 | 0.00 | 0.00 | 15.00 |
| HERBALIME | 8006-64-2 | 0.00 | 0.00 | 40.00 |
| HEXYL CINN ALD TBHQ | 101-86-0 | 0.00 | 5.10 | 0.00 |
| ISO BORNYL ACET | 125-12-2 | 182.86 | 80.00 | 50.00 |
| JAVAMOR TT (ELINCS) | 198404-98-7 | 0.00 | 0.00 | 4.00 |
| MANZANATE | 39255-32-8 | 0.00 | 0.00 | 35.00 |
| MELONAL TOCO | 106-72-9 | 0.00 | 0.00 | 30.00 |
| METH DH JASMONATE | 24851-98-7 | 0.00 | 35.00 | 0.00 |
| METH IONONE GAMMA | 127-51-5 | 0.00 | 0.00 | 150.00 |
| “FF” TOCO | | | | |
| METH IONONE GAMMA | 127-51-5 | 0.00 | 40.00 | 0.00 |
| A TOCO | | | | |
| METH PHEN ETH ETHER | 3558-60-9 | 0.00 | 0.00 | 3.00 |
| MONTAVERDI (ELINCS) | 188570-78-7 | 0.00 | 0.00 | 7.50 |
| ORANGE FLOWER | 14576-08-0 | 85.71 | 85.00 | 0.00 |
| ETHER TOCO | | | | |
| PAMPLEZEST | 1465004-85-6 | 0.00 | 0.00 | 15.00 |
| PINO ACETALD TOCO | 33885-51-7 | 0.00 | 0.00 | 40.00 |
| ROSYRANE SUPER | 60335-71-9 | 0.00 | 0.00 | 30.00 |
| TERPINOLENE P UB | 586-62-9 | 57.14 | 130.00 | 0.00 |
| TOCO | | | | |
| TETRAHYDRO | 78-69-3 | 22.76 | 70.00 | 39.00 |
| LINALOOL | | | | |
| TETRAHYDRO LINALYL | 68480-08-0 | 0.00 | 55.00 | 0.00 |
| ACET | | | | |
| TETRAHYDRO | 18479-57-7 | 21.76 | 60.00 | 0.00 |
| MYRCENOL | | | | |
| | Total | 1000 | 1000 | 1000 |

¹ Available from International Flavors & Fragrances Inc. (New York).

### Example 2a: Visco-Stability Improvement with Encapsulated High Performance Fragrances

The aim of this example is to show the visco-stability benefit of using encapsulated High Performance fragrances to the fabric conditioner product. The addition of encapsulated fragrances into a fabric conditioner composition causes disruptions to the system which can affect the technical parameters of the system (e.g., viscosity). High Performance fragrances are designed to be used at lower doses (i.e., up to 10 times lower than a standard fragrance). This means that when dosing with encapsulated High Performance fragrances, there should be less disturbance to the base system. Therefore, the effect of an encapsulated High Performance fragrance of the present invention on the visco-stability of the fabric conditioner composition is assessed.

Samples of fragrance slurry, water and fabric conditioner base are made for measuring visco-stability over time. One regular fragrance composition (Comparative Fragrance Examples 1) not containing the High Performance fragrance ingredients, in the specified amounts, and two fragrance compositions according to the present invention (High Performance Fragrance Examples 2 & 3) are used. Formulations for the fabric conditioner base is provided in Table 5 below. Samples are tested in a 19% fabric conditioner active base as is, and also diluted with water to create a 12% active level base.

TABLE 5
Fabric Conditioner Base (19% active level)

| Material | Amount (g) |
|---|---|
| REWOQUAT ® WE 18 (Esterquat; Evonik, 90% in IPA) | 23.46 |
| PROXEL ® GLX (1,2-benzisothiazolin-3-one) | 0.11 |
| Water | 76.1 |
| Calcium Chloride (25%) | 0.33 |

For the visco-stability assessment, samples are stored at four temperatures: 5° C., 20° C. (room temperature), 37° C. and 40° C. Viscosity is measured initially (t=0 days) and then periodically at 4-week intervals. Viscosity was measured using an HTR 302 compact machine and measurements were taken at shear rates of 2/s, 20/s & 106/s (rotations per second). The results of the viscosity measurements are then averaged in Tables 6A-6D and discussed below.

TABLE 6A
Viscosity Measurements at storage temperature 5° C.

| | |
|---|---|
| Storage time | Viscosity (cPas) |

| Fragrance | NOE | (weeks) | 2/s | 20/s | 106/s |
|---|---|---|---|---|---|
| Comparative | 0.24 | 0 | 107 | 61.2 | 43.7 |
| Fragrance | | 4 | 119.0 | 66.0 | 48.0 |
| Example 1 | | 8 | 142.8 | 73.6 | 52.8 |
| | | 12 | 139.9 | 74.9 | 53.3 |
| | | 16 | 154.1 | 79.2 | 56.6 |
| | | 20 | 152.4 | 82.3 | 58.8 |
| High | 0.12 | 0 | 204 | 68 | 41.5 |
| Performance | | 4 | 88.3 | 52.6 | 40.0 |
| Fragrance | | 8 | 95.0 | 56.6 | 43.0 |
| Example 2 | | 12 | 97.7 | 58.0 | 44.0 |
| | | 16 | 111.1 | 61.0 | 46.0 |
| | | 20 | 106.9 | 63.0 | 47.6 |
| High | 0.1 | 0 | 87.3 | 49.4 | 37 |
| Performance | | 4 | 75.2 | 46.3 | 36.3 |
| Fragrance | | 8 | 113.2 | 63.0 | 46.9 |
| Example 3 | | 12 | 79.8 | 49.0 | 38.6 |
| | | 16 | 84.9 | 51.4 | 40.1 |
| | | 20 | 84.3 | 52.9 | 41.6 |

TABLE 6B
Viscosity Measurements at storage temperature 20° C.

| | |
|---|---|
| Storage time | Viscosity (cPas) |

| Fragrance | NOE | (weeks) | 2/s | 20/s | 106/s |
|---|---|---|---|---|---|
| Comparative | 0.24 | 0 | 107 | 61.2 | 43.7 |
| Fragrance | | 4 | 81.9 | 49.0 | 37.4 |
| Example 1 | | 8 | 143.4 | 75.1 | 53.7 |
| | | 12 | 84.7 | 50.0 | 38.0 |
| | | 16 | 80.2 | 48.0 | 37.0 |
| | | 20 | 81.6 | 49.0 | 37.4 |
| High | 0.12 | 0 | 204 | 68 | 41.5 |
| Performance | | 4 | 68.4 | 42.3 | 33.2 |
| Fragrance | | 8 | 103.7 | 58.8 | 44.4 |
| Example 2 | | 12 | 67.3 | 41.9 | 33.0 |
| | | 16 | 68.1 | 42.0 | 33.0 |
| | | 20 | 69.1 | 43.0 | 34.0 |
| High | 0.1 | 0 | 87.3 | 49.4 | 37 |
| Performance | | 4 | 60.8 | 39.0 | 31.2 |
| Fragrance | | 8 | 86.3 | 51.4 | 40.1 |
| Example 3 | | 12 | 60.2 | 37.0 | 30.0 |
| | | 16 | 58.4 | 37.0 | 30.0 |
| | | 20 | 56.3 | 36.0 | 29.0 |

TABLE 6C
Viscosity Measurements at storage temperature 37° C.

| | |
|---|---|
| Storage time | Viscosity (cPas) |

| Fragrance | NOE | (weeks) | 2/s | 20/s | 106/s |
|---|---|---|---|---|---|
| Comparative | 0.24 | 0 | 107 | 61.2 | 43.7 |
| Fragrance | | 4 | 120.4 | 61.3 | 47.0 |
| Example 1 | | 8 | 112.8 | 62.8 | 46.3 |
| | | 12 | 142.3 | 79.0 | 59.2 |
| | | 16 | 196.2 | 103.1 | 77.2 |
| | | 20 | 609.6 | 245.3 | 165.0 |
| High | 0.12 | 0 | 204 | 68 | 41.5 |
| Performance | | 4 | 100.2 | 54.0 | 41.1 |
| Fragrance | | 8 | 79.9 | 48.7 | 38.0 |
| Example 2 | | 12 | 122.3 | 68.0 | 51.2 |
| | | 16 | 149.3 | 83.7 | 64.2 |
| | | 20 | 316.1 | 153.6 | 112.6 |
| High | 0.1 | 0 | 87.3 | 49.4 | 37 |
| Performance | | 4 | 78.7 | 45.6 | 37.0 |
| Fragrance | | 8 | 67.1 | 42.3 | 34.0 |
| Example 3 | | 12 | 100.4 | 59.6 | 46.2 |
| | | 16 | 132.3 | 77.2 | 60.9 |
| | | 20 | 268.4 | 139.6 | 106.8 |

TABLE 6D
Viscosity Measurements at storage temperature 40° C.

| | |
|---|---|
| Storage time | Viscosity (cPas) |

| Fragrance | NOE | (weeks) | 2/s | 20/s | 106/s |
|---|---|---|---|---|---|
| Comparative | 0.24 | 0 | 107 | 61.2 | 43.7 |
| Fragrance | | 4 | 159.0 | 79.0 | 56.0 |
| Example 1 | | 8 | 128.7 | 73.0 | 54.2 |
| | | 12 | 226.4 | 116.1 | 85.3 |
| High | 0.12 | 0 | 204 | 68 | 41.5 |
| Performance | | 4 | 174.0 | 73.0 | 51.0 |
| Fragrance | | 8 | 111.8 | 64.1 | 49.0 |
| Example 2 | | 12 | 191.9 | 99.9 | 74.1 |
| High | 0.1 | 0 | 87.3 | 49.4 | 37 |
| Performance | | 4 | 120.0 | 68.0 | 48.0 |
| Fragrance | | 8 | 91.2 | 55.0 | 43.0 |
| Example 3 | | 12 | 162.2 | 89.8 | 69.8 |

FIG. 1 is a graphic depiction of the results, which comprises the inventive High Performance Fragrance Examples 2 & 3 and the Comparative Fragrance Example 1, all in 19% fabric conditioner active bases. As shown by FIG. 1, the addition of encapsulated fragrance composition comprising High Performance fragrance ingredients of the present invention into a fabric conditioner base (i.e., High Performance Fragrance Examples 2 & 3), maintains the overall product viscosity without an appreciable increase over time. In contrast, the Comparative Fragrance Examples 1, in the absence of the High Performance fragrance ingredients, increases in viscosity over the 20 weeks at 37° C. (i.e., representative of accelerated stability testing) leading to negative impact on flowability/pourability, etc. Therefore, when using an encapsulated High Performance fragrance according to the present invention, a lower dose of slurry can be used thereby minimizing interruptions (e.g., downstream visual impacts to flowability/pourability) to the total product formula while maintaining parity or increased fragrance performance (see Example 2b).

### Example 2b: Fragrance Performance with Encapsulated High Performance Fragrances

The aim of this example is to show the fragrance performance benefit of using encapsulated High Performance fragrances in the fabric conditioner product. High Performance fragrances are designed to be used at lower doses (i.e., up to 10 times lower than a standard fragrance). Theoretically, if a standard fragrance is dosed at 10 times less, then a corresponding reduction in fragrance performance is expected. Because High Performance fragrances are meant to be dosed this low, the same drop in fragrance performance is not expected. Therefore, the effect of an encapsulated High Performance fragrance of the present invention on the fragrance performance of the fabric conditioner composition is assessed.

Fabric conditioner composition comprising fragrance compositions in Tables 3 and 4 are washed with laundry as described in Example 2a and a panel of 12 experienced panelists evaluated the perceived fragrance profile at dry pre and gentle handling stages of the wash process according to the evaluation described in the Test Methods. The results from the sensory panelists are then averaged and discussed below.

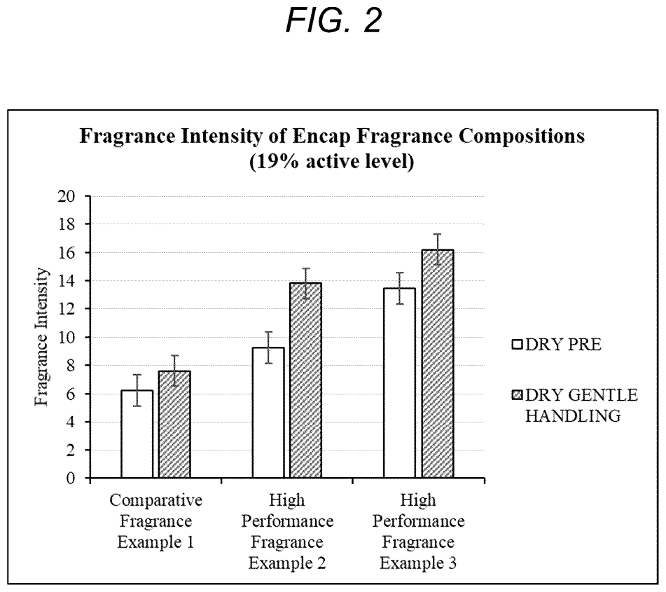

FIG. 2 is a graphic depiction of the results, which comprises the Fragrance Intensity scores (assessed by a trained sensory panel, at dry pre and dry gentle handling stages) of inventive High Performance Fragrance Examples 2 & 3 and the Comparative Fragrance Example 1, all in 19% fabric conditioner active bases. As shown by FIG. 2, the addition of encapsulated fragrance composition comprising High Performance fragrance ingredients of the present invention into a fabric conditioner base (i.e., High Performance Fragrance Examples 2 & 3), improves fragrance intensity at dry pre and dry gentle handling stages when compared to a benchmark encapsulated fragrance composition (i.e. Comparative Fragrance Example 1). Therefore, when using an encapsulated High Performance fragrance according to the present invention, fragrance intensity perception at dry pre and dry gentle handling stages can be further improved while a lower dose of slurry is used.

### Example 3: Preparation of Neat Fragrance Compositions

Two High Performance fragrance compositions are prepared (High Performance Fragrance Examples 3 & 4), alongside with two commercial benchmarks (Benchmark Fragrance Examples 1 & 2), as provided in Table 7.

TABLE 7
Fragrance Compositions

| | | Benchmark | Benchmark | High Performance | |
|---|---|---|---|---|---|
| | | Fragrance | Fragrance | Fragrance (ppt) | |
| | | Example 1 | Example 2 | Example | Example |
| Ingredient | CAS Number | (ppt) | (ppt) | 3 | 4 |
| ACET C-6 | 142-92-7 | 0.00 | 40.01 | 0.00 | 0.00 |
| ACETOPHENONE | 98-86-2 | 0.00 | 4.00 | 0.00 | 0.00 |
| ADOXAL TOCO | 141-13-9 | 0.00 | 5.50 | 0.00 | 0.00 |
| ALD AA TRIPLAL | 68039-49-6 | 0.00 | 9.20 | 0.00 | 0.00 |
| TOCO | | | | | |
| ALD C-11 ULENIC | 112-45-8 | 5.52 | 28.01 | 0.00 | 0.00 |
| TOCO | | | | | |
| ALD C-12 LAURIC | 112-54-9 | 7.53 | 38.51 | 0.00 | 0.00 |
| TOCO | | | | | |
| ALD C-12 MNA | 110-41-8 | 6.22 | 30.51 | 100.00 | 0.00 |
| TOCO | | | | | |
| ALD C-18 NAT | 104-61-0 | 0.00 | 0.00 | 0.00 | 135.14 |
| DERIVED CSM | | | | | |
| ALLYL PHENOXY | 7493-74-5 | 0.00 | 4.40 | 0.00 | 0.00 |
| ACET | | | | | |
| AMBER CORE | 139504-68-0 | 0.50 | 0.00 | 0.00 | 0.00 |
| (ELINCS) TOCO | | | | | |
| AMBER XTREME | 476332-65-7, | 1.51 | 0.00 | 0.00 | 22.30 |
| TM | 647828-16-8 | | | | |
| AMBERMOR EX | 6790-58-5 | 0.00 | 1.20 | 200.00 | 13.51 |
| AMYL SAL | 87-20-7 | 13.85 | 23.50 | 0.00 | 0.00 |
| ANETHOLE 21/22 | 4180-23-8 | 1.10 | 0.00 | 0.00 | 0.00 |
| TOCO | | | | | |
| ARBANOL GLID | 7070-15-7 | 2.01 | 0.00 | 0.00 | 0.00 |
| AUBEPINE | 123-11-5 | 0.00 | 12.50 | 0.00 | 0.00 |
| BACDANOL TOCO | 106185-75-5 | 1.41 | 0.00 | 0.00 | 0.00 |
| BENZ ACET | 140-11-4 | 2.11 | 28.51 | 0.00 | 0.00 |
| BENZ ACETONE | 2550-26-7 | 0.00 | 1.60 | 0.00 | 0.00 |
| BENZ SAL | 118-58-1 | 77.28 | 2.70 | 0.00 | 0.00 |
| BENZOIC ACID | 65-85-0 | 0.30 | 0.00 | 0.00 | 0.00 |
| BERGAMAL TOCO | 22418-66-2 | 0.00 | 0.00 | 0.00 | 13.51 |
| BORNEOL 10% DPG | 464-43-7, | 0.50 | 0.00 | 0.00 | 0.00 |
| | 464-45-9 | | | | |
| BUTYL ACET | 123-86-4 | 0.00 | 0.30 | 0.00 | 0.00 |
| CAMPHOR PWD | 76-22-2 | 1.91 | 0.00 | 0.00 | 0.00 |
| SYN | | | | | |
| CANTHOXAL TOCO | 5462-06-6 | 0.20 | 0.00 | 0.00 | 0.00 |
| CARVACROL CP | 499-75-2 | 1.00 | 0.00 | 0.00 | 0.00 |
| 10% DPG USE | | | | | |
| 00038979 | | | | | |
| CARYOPHYLLENE | 87-44-5 | 4.32 | 0.00 | 0.00 | 0.00 |
| CASHMERAN | 33704-61-9 | 0.00 | 0.00 | 200.00 | 0.00 |
| CEDARWOOD | 68990-83-0 | 1.00 | 0.00 | 0.00 | 0.00 |
| LIGHT TEXAS | | | | | |
| CEDRAMBER | 67874-81-1 | 0.00 | 0.20 | 0.00 | 0.00 |
| CINN ALC | 104-54-1 | 0.60 | 0.00 | 0.00 | 0.00 |
| CITRAL HLR | 141-27-5 | 4.01 | 0.00 | 0.00 | 0.00 |
| CITRATHAL 80 PCT | 147060-73-9 | 5.02 | 0.00 | 0.00 | 0.00 |
| ETOH | | | | | |
| CITRONELLOL 950 | 106-22-9 | 0.00 | 14.50 | 0.00 | 0.00 |
| CITRONELLYL | 150-84-5 | 0.00 | 0.20 | 0.00 | 0.00 |
| ACET | | | | | |
| CITRONELLYL | 105-85-1 | 1.00 | 0.00 | 0.00 | 0.00 |
| FORMATE 10% IPM | | | | | |
| (MB) | | | | | |
| CORANOL | 83926-73-2 | 0.00 | 2.30 | 0.00 | 0.00 |
| (ELINCS) EXCL | | | | | |
| COUMARIN | 91-64-5 | 9.74 | 0.00 | 0.00 | 0.00 |
| CUMINIC ALD | 122-03-2, | 1.00 | 0.00 | 0.00 | 0.00 |
| TOCO 10% DPG | 10191-41-0 | | | | |
| CYCLAMAL TOCO | 103-95-7 | 12.55 | 33.01 | 0.00 | 0.00 |
| CYCLAPROP | 68912-13-0 | 0.00 | 0.50 | 0.00 | 0.00 |
| CYCLOHEXYL SAL | 25485-88-5 | 0.00 | 2.50 | 0.00 | 0.00 |
| (ELINCS) | | | | | |
| DAMASCENONE | 23696-85-7 | 0.20 | 0.00 | 0.00 | 0.00 |
| TOTAL TOCO | | | | | |
| DAMASCONE | 71048-82-3 | 2.61 | 3.00 | 0.00 | 0.00 |
| DELTA TOCO | | | | | |
| DECALACTONE, | 706-14-9 | 0.00 | 5.30 | 0.00 | 0.00 |
| GAMMA | | | | | |
| DELPHONE | 4819-67-4 | 0.00 | 0.00 | 0.00 | 2.70 |
| DIHYDRO | 18479-58-8 | 0.00 | 128.53 | 0.00 | 0.00 |
| MYRCENOL | | | | | |
| DIMETH BENZ | 151-05-3 | 0.00 | 26.51 | 0.00 | 0.00 |
| CARB ACET | | | | | |
| DOWANOL DPM | 34590-94-8 | 1.30 | 1.10 | 0.00 | 0.00 |
| ETH LINALOOL | 10339-55-6 | 0.00 | 0.30 | 0.00 | 0.00 |
| TOCO | | | | | |
| ETH VANILLIN | 121-32-4 | 7.23 | 0.80 | 0.00 | 0.00 |
| ETHYLENE | 105-95-3 | 0.00 | 1.40 | 0.00 | 0.00 |
| BRASSYLATE(AST | | | | | |
| RATONE) | | | | | |
| EUGENOL NAT EX | Natural oil | 28.60 | 24.00 | 0.00 | 0.00 |
| CLOVE LEAF OIL | | | | | |
| CSM | | | | | |
| FLORHYDRAL | 125109-85-5 | 0.00 | 3.60 | 0.00 | 0.00 |
| TOCO (ELINCS) | | | | | |
| FLORIFFOL | 63500-71-0 | 184.66 | 24.50 | 0.00 | 0.00 |
| (ELINCS) TOCO | | | | | |
| GALBASCONE | 56973-85-4 | 0.00 | 0.60 | 0.00 | 0.00 |
| ALPHA 95 PRG | | | | | |
| TOCO | | | | | |
| GALBASCONE PRG | 56973-85-4, | 0.70 | 0.00 | 0.00 | 0.00 |
| TOCO | 56973-84-3 | | | | |
| GERANIOL 980 | 106-24-1 | 3.11 | 10.50 | 0.00 | 0.00 |
| PURE | | | | | |
| GERANYL ACET | 105-87-3 | 15.36 | 0.00 | 0.00 | 0.00 |
| PURE | | | | | |
| GERANYL PROP | 105-90-8 | 0.00 | 0.40 | 0.00 | 0.00 |
| GUAIACOL LIQ SD | 90-05-1 | 0.00 | 0.00 | 0.00 | 10.14 |
| 1% DPG | | | | | |
| GUAIACWOOD OIL | Natural oil | 1.00 | 0.00 | 0.00 | 0.00 |
| CSM ³ | | | | | |
| HABANOLIDE | 111879-80-2, | 23.08 | 10.50 | 0.00 | 0.00 |
| (ELINCS) | 32539-78-9 | | | | |
| HELIONAL | 1205-17-0 | 0.00 | 0.20 | 0.00 | 0.00 |
| HELIOTROPINE | 120-57-0 | 1.30 | 3.20 | 0.00 | 0.00 |
| (PIPERONAL) | | | | | |
| (USDEA) | | | | | |
| HELVETOLIDE | 141773-73-1 | 0.00 | 14.50 | 0.00 | 0.00 |
| (ELINCS) | | | | | |
| HEXADECANOLIDE | 109-29-5 | 0.00 | 0.00 | 0.00 | 67.57 |
| HEXYL CINN ALD | 101-86-0 | 234.85 | 40.01 | 0.00 | 0.00 |
| TBHQ | | | | | |
| HEXYL SAL | 6259-76-3 | 41.15 | 19.50 | 0.00 | 0.00 |
| HYDRATROPIC | 1123-85-9 | 0.50 | 0.00 | 0.00 | 0.00 |
| ALC COEUR | | | | | |
| HYDROXYCIT | 107-75-5 | 0.30 | 0.00 | 0.00 | 0.00 |
| PURE SYN | | | | | |
| INDISAN NEAT | 3407-42-9 | 1.61 | 0.00 | 0.00 | 0.00 |
| IONONE ALPHA | 127-41-3 | 0.00 | 8.10 | 0.00 | 0.00 |
| TOCO | | | | | |
| ISO AMYL BUTY | 106-27-4 | 0.00 | 5.70 | 0.00 | 0.00 |
| ISO BUTYL | 67634-06-4 | 0.00 | 0.00 | 0.00 | 4.73 |
| QUINOLINE 10% | | | | | |
| DPG | | | | | |
| ISO BUTYL | 67634-06-4 | 0.00 | 1.00 | 0.00 | 0.00 |
| QUINOLINE 10% | | | | | |
| TEC | | | | | |
| ISO E SUPER TOCO | 54464-57-2 | 67.24 | 9.00 | 0.00 | 0.00 |
| ISO EUGENOL | 97-54-1 | 0.20 | 0.00 | 0.00 | 0.00 |
| JAVANOL TT | 198404-98-7 | 0.00 | 0.00 | 0.00 | 108.11 |
| (ELINCS) | | | | | |
| LINALOOL PURE | 78-70-6 | 0.00 | 136.03 | 0.00 | 0.00 |
| EX PINENE | | | | | |
| LINALOOL SYN | 78-70-6 | 16.56 | 0.00 | 0.00 | 0.00 |
| TOCO | | | | | |
| LINALYL ACET | 115-95-7 | 0.00 | 0.50 | 0.00 | 0.00 |
| LINDENOL | 98-55-5 | 0.50 | 4.00 | 0.00 | 0.00 |
| MEIJIFF TOCO | 5502-75-0 | 0.60 | 0.00 | 0.00 | 0.00 |
| METH ANTH | 134-20-3 | 0.20 | 0.00 | 0.00 | 0.00 |
| (USDEA) | | | | | |
| METH BENZOATE | 93-58-3 | 0.50 | 0.00 | 0.00 | 0.00 |
| METH BENZOATE | 93-58-3 | 0.00 | 0.00 | 0.00 | 18.92 |
| NAT DERIVED CSM | | | | | |
| METH BETA NAPH | 93-08-3 | 2.51 | 0.00 | 0.00 | 0.00 |
| KETONE | | | | | |
| METH CEDRYL | 32388-55-9 | 0.00 | 0.40 | 0.00 | 0.00 |
| KETONE | | | | | |
| METH DH | 24851-98-7 | 16.66 | 31.01 | 0.00 | 0.00 |
| JASMONATE | | | | | |
| METH IONONE | 127-51-5 | 77.28 | 0.00 | 0.00 | 0.00 |
| GAMMA A TOCO | | | | | |
| METH NONYL | 112-12-9 | 0.20 | 0.60 | 0.00 | 0.00 |
| KETONE | | | | | |
| METH PARA | 104-93-8 | 0.40 | 0.00 | 0.00 | 0.00 |
| CRESOL | | | | | |
| MUSCEMOR | 82356-51-2 | 0.00 | 0.00 | 200.00 | 0.00 |
| (ELINCS) | | | | | |
| MUSCENONE | 63314-79-4 | 0.00 | 0.00 | 0.00 | 27.03 |
| (ELINCS) | | | | | |
| NEROL SUPER | 106-25-2 | 1.30 | 5.80 | 0.00 | 0.00 |
| VERNOL | | | | | |
| NERYL ACET A | 141-12-8 | 7.23 | 0.00 | 0.00 | 0.00 |
| OCEANOL | 33662-58-7 | 0.00 | 0.00 | 0.00 | 20.27 |
| ORANGE TERPENES | 8028-48-6 | 15.05 | 0.00 | 0.00 | 0.00 |
| EX 5X TOCO | | | | | |
| PATCHONE | 98-52-2 | 10.04 | 0.00 | 0.00 | 0.00 |
| PATCHOULI OIL | Natural oil | 12.55 | 65.01 | 0.00 | 0.00 |
| LIGHT BLO CSM ¹ | | | | | |
| PAXAMBER | 23787-90-8 | 0.00 | 1.00 | 0.00 | 0.00 |
| PEONILE (ELINCS) | 10461-98-0 | 37.64 | 0.70 | 0.00 | 0.00 |
| PHEN ETH ALC | 60-12-8 | 0.00 | 22.00 | 0.00 | 0.00 |
| WHITE EXTRA | | | | | |
| (MXDEA) | | | | | |
| PHEN ETH ALC | 60-12-8 | 3.31 | 0.00 | 0.00 | 0.00 |
| WHITE EXTRA | | | | | |
| (MXDEA) | | | | | |
| PHEN ETH SAL | 87-22-9 | 3.21 | 0.00 | 0.00 | 0.00 |
| PHENOXANOL | 55066-48-3 | 0.00 | 7.30 | 0.00 | 0.00 |
| PHENOXY ETHYL | 103-60-6 | 0.00 | 0.50 | 0.00 | 0.00 |
| ISO BUTY | | | | | |
| PINO ACETALD | 33885-51-7 | 0.00 | 0.00 | 50.00 | 40.54 |
| TOCO | | | | | |
| PLINOL SPECIAL | 72402-00-7 | 0.30 | 0.00 | 0.00 | 0.00 |
| ROSE OXIDE TOCO | 16409-43-1 | 2.01 | 12.50 | 0.00 | 0.00 |
| ROSETHYL | 64988-06-3 | 0.00 | 0.00 | 200.00 | 0.00 |
| SCENTENAL | 86803-90-9 | 1.00 | 0.00 | 0.00 | 0.00 |
| (ELINCS) BHT | | | | | |
| SINENSAL | Natural oil | 0.00 | 0.00 | 0.00 | 9.46 |
| NATURAL 20 EX | | | | | |
| ORANGE ² | | | | | |
| STYRALYL ACET | 93-92-5 | 0.00 | 0.60 | 0.00 | 7.43 |
| TERPINYL ACET | 8007-35-0 | 1.00 | 0.00 | 0.00 | 0.00 |
| JAX | | | | | |
| TRISAMBER | 351343-77-6 | 0.00 | 0.00 | 0.00 | 337.84 |
| (ELINCS) | | | | | |
| UNDECALACTONE | 104-67-6 | 6.52 | 0.90 | 0.00 | 0.00 |
| GAMMA COEUR | | | | | |
| UNDECALACTONE, | 710-04-3 | 0.00 | 0.00 | 0.00 | 89.19 |
| DELTA | | | | | |
| UNDECAVERTOL | 81782-77-6 | 0.00 | 37.01 | 0.00 | 44.59 |
| TOCO | | | | | |
| VELTOL PLUS | 8-11-4940 | 0.00 | 0.00 | 0.00 | 13.51 |
| VERAMOSS | 4707-47-5 | 0.50 | 0.00 | 0.00 | 0.00 |
| VERTENEX | 32210-23-4 | 0.00 | 47.51 | 0.00 | 0.00 |
| VERTOLIFF TOCO | 36635-35-5 | 5.02 | 0.00 | 0.00 | 0.00 |
| VIOLIFF BHT | 87731-18-8 | 0.00 | 0.00 | 0.00 | 13.51 |
| (ELINCS) | | | | | |
| YARA YARA | 93-04-9 | 0.00 | 0.00 | 50.00 | 0.00 |
| EXTRA PRG | | | | | |
| YSAMBER K | 154171-77-4 | 0.70 | 0.70 | 0.00 | 0.00 |
| (ELINCS) | | | | | |
| | Total | 1000.00 | 1000.00 | 1000.00 | 1000.00 |

¹ Available from TRIPPER PTE Ltd. (Indonesia).
² Available from TREATT & CO. Ltd. (United Kingdom).
³ Available from AMIGO & ARDITI S.A. (Paraguay).

### Example 4: Fragrance Performance with Neat High Performance Fragrances

The aim of this example is to show sensorial benefits for using neat High Performance fragrance ingredients with a wider variety of fabric conditioner base types compared to a standard fragrance. As with capsules, when adding a neat fragrance oil to a fabric conditioner base, the total system changes its properties and needs for performance.

In a fabric conditioner composition, the fabric softening agent (e.g., the quat) in the base not only acts as an active but also functions as a deposition aid for a neat oil fragrance introduced to the system, and aids in its hedonics performance. Fabric conditioner bases have a wide variety of active levels ranging from 2% (low) to 19% (high), which can typically have a large effect on the amount of deposition aid available for a neat oil fragrance.

Four different active concentration bases are created, using the same 19% active level base described in Example 2. The 19% concentration is used, and then the base is diluted with water to 12%, 8% and 2% active levels. The two High Performance Fragrance Examples 3 & 4 are dosed at 0.1%, and the Benchmark Fragrance Examples 1 & 2 are dosed at 1.0%. Samples are washed and evaluated with a trained sensory panel for perceived fragrance intensity as described in Example 2. The results from the sensory panelists are then averaged in Table 8 and discussed below.

TABLE 8
Fragrance Compositions

| | High | Ultra High- | High- | Bio- | |
|---|---|---|---|---|---|
| | Performance | Impact | Impact | Renewable | |
| | Fragrance | Fragrance | Fragrance | Carbon | |
| | Ingredients | Ingredients | Ingredients | Content | Odor |
| Fragrance | (wt %) | (wt %) | (wt %) | (wt %) | Potency |
| Benchmark Fragrance | 9.49 | 0.22 | 9.27 | 20 | 531 |
| Example1 | | | | | |
| Benchmark Fragrance | 29.70 | 0.18 | 29.52 | 45 | 1311 |
| Example 2 | | | | | |
| High Performance | 100.00 | 20.00 | 80.00 | 34 | 13729 |
| Fragrance Example 3 | | | | | |
| High Performance | 95.00 | 4.00 | 91.00 | 35 | 13861 |
| Fragrance Example 4 | | | | | |

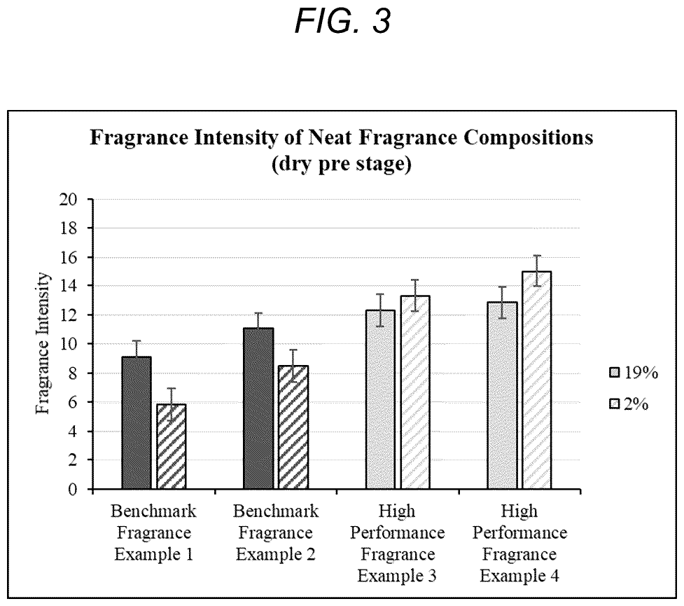

Table 8 provides a summary of fragrance compositions comprising selected fragrances/fabric conditioner active levels. The results are presented in FIG. 3, where it shows that the High Performance Fragrance Examples 3 and 4 do not lose performance (intensity) between the highest (19%) and the lowest (2%) fabric conditioner active levels. In contrast, lowering the fabric conditioner active level from 19% to 2% for Benchmark Fragrance Examples 1 and 2 results in a statistically significant drop in performance (intensity) compared to the higher active levels. The results herein demonstrate that when using a High Performance fragrance composition of the present invention, deposition aid levels in the fabric conditioner composition can be reduced without negatively impacting fragrance profile. Therefore, parity or higher fragrance performance can be achieved in with a fabric conditioning active at a level of 2% to 19%.

### Example 5: Fragrance Profile Improvement with Neat High Performance Fragrances

The aim of this example is to show hedonic (i.e., character) benefits for using neat High Performance fragrance ingredients with a wider variety of fabric conditioner based types compared to a standard fragrance. Theoretically, if a standard fragrance is dosed into a fabric conditioner base having lower active level, then there is a higher risk of hedonic differences as less of the full fragrance will deposit onto the cloth and therefore may not survive the wash. As a result, key hedonic characters from the standard fragrance will be loss. In comparison, High Performance fragrances are designed to be used at lower doses. Thus, there is less risk in hedonic differences as it is more likely that the full fragrance will deposit onto the cloth. Therefore, the effect of neat High Performance fragrance of the present invention on the hedonic benefits of the fabric conditioner composition is assessed.

Four different active concentration bases are created, using the same 19% active level base described in Example 2. The 19% concentration is used, and then the base is diluted with water to 12%, 8% and 2% active levels. The two High Performance Fragrance Examples 3 & 4 are dosed at 0.1%, and the Benchmark Fragrance Examples 1 & 2 are dosed at 1.0% (all disclosed in Example 3). Samples are washed and evaluated with expert panelists for perceived hedonics differences for each sample as the active level is dropped. Samples are partially blinded, meaning the panelists knew which sample it was but did not know the active level of the sample. The results from the sensory panelists are then summarized and discussed below.

The results show that the hedonics, particularly the characters derived from the top and heart notes, change more for Benchmark Fragrance Examples 1 & 2 than the High Performance Fragrance Examples 3 & 4, especially when the active level of the fabric conditioner is lowered (data not shown). When the active level is dropped to 2%, the Benchmark Fragrance Examples 1 & 2 lose most of their top and/or heart notes whereas the High Performance Fragrance Examples 3 & 4 maintain these aspects. Therefore, consistent character hedonics, particularly derived from top and/or heart notes, can be achieved by using fabric conditioner composition comprising High Performance fragrances of the present invention, even at low active levels.

### Example 6: Exemplary Fabric Softener Composition

Composition A is an example of fabric conditioner composition according to the present invention. It is prepared by admixture of the components described in Table 9 in the proportions indicated.

TABLE 9
Fabric Condition Composition

| | Composition II |
|---|---|
| Ingredient | (wt %¹) |
| fabric conditioner base³ | 90 |
| Microcapsules (Fragrance A)² | 0.3-3.0 |
| DI-Water | Qs |
| Total | 100 |

¹wt % relative to the total weight of the composition.
²Encapsulated amount depends on the fragrance loading to 0.2% NOE. Fragrance A is any one of High Performance Fragrance Example 3 (Table 4; Example 1), or High Performance Fragrance Examples 3 & 4 (Table 7; Example 3).
³Fabric conditioner base per Table 5 (Example 2a).

What is claimed is:

1. An aqueous fabric conditioner composition comprising:
(i) a fragrance component present in an amount of ≤1 wt % relative to the total weight of the composition, wherein the fragrance component comprises: (a) at least one, at least two, at least three, at least four, at least five, at least six, at least seven, at least eight, at least nine or at least ten High Performance fragrance ingredients selected from the group consisting of Ultra High-Impact fragrance ingredients as listed in Table 1 and High-Impact fragrance ingredients as listed in Table 2; and
(ii) a fabric conditioner active.

2. The aqueous fabric conditioner composition of claim 1, wherein the fragrance component is a neat fragrance, an encapsulated fragrance or a combination thereof, and is present in the amount of 0.01 wt % to 1 wt % relative to the total weight of the composition, and the weight ratio of the Ultra High-Impact fragrance ingredients to the High-Impact fragrance ingredients ranges from 1:0 to 1:19.

3. The aqueous fabric conditioner composition of claim 2, wherein:
the Ultra High-Impact fragrance ingredients are present in an amount of ≥5 wt %, ≥10 wt %, ≥15 wt %, ≥20 wt %, ≥25 wt %, 30 wt %, ≥35 wt %, ≥40 wt %, ≥45 wt %, ≥50 wt %, ≥55 wt %, ≥60 wt %, ≥65 wt %, ≥70 wt %, ≥75 wt %, ≥80 wt %, ≥85 wt %, ≥90 wt % or ≥95 wt %, preferably ≥5 wt %, ≥10 wt %, ≥15 wt % or ≥20 wt %, relative to the total weight of the High Performance fragrance ingredients; and
the High-Impact fragrance ingredients are present in an amount of ≤95 wt %, ≤90 wt %, ≤85 wt %, ≤80 wt %, ≤75 wt %, ≤70 wt %, ≤65 wt %, ≤60 wt %, ≤55 wt %, ≤50 wt %, ≤45 wt %, ≤40 wt %, ≤35 wt %, ≤30 wt %, ≤25 wt %, ≤20 wt %, ≤15 wt %, ≤10 wt % or ≤5 wt %, preferably ≤95 wt %, ≤90 wt %, ≤85 wt % or ≤80 wt %, relative to the total weight of the High Performance fragrance ingredients.

4. The aqueous fabric conditioner composition of claim 2, wherein the fragrance component is a neat fragrance and further comprises (b) additional fragrance ingredients, and the weight ratio of (a) to (b) ranges from 3:1 to 19:1.

5. The aqueous fabric conditioner composition of claim 4, wherein:
the High Performance fragrance ingredients are present in an amount of ≥75 wt %, ≥80 wt %, ≥85 wt %, ≥90 wt % or ≥95 wt % relative to the total weight of the fragrance component; and
the additional fragrance ingredients are present in an amount of ≤25 wt %, ≤20 wt %, ≤15 wt %, ≤10 wt % or ≤5 wt % relative to the total weight of the fragrance component.

6. The aqueous fabric conditioner composition of claim 2, wherein the fragrance component is an encapsulated fragrance and further comprises (b) additional fragrance ingredients, and the weight ratio of (a) to (b) ranges from 1.2:1 to 3:1.

7. The aqueous fabric conditioner composition of claim 6, wherein:
the High Performance fragrance ingredients are present in an amount of ≥55 wt %, ≥60 wt %, ≥65 wt %, at ≥70 wt %, ≥75 wt %, ≥80 wt %, ≥85 wt % or ≥90 wt % relative to the total weight of the fragrance component; and
the additional fragrance ingredients are present in an amount of ≤45 wt %, ≤40 wt %, ≤35 wt %, ≤30 wt %, ≤25 wt %, ≤20 wt %, ≤15 wt % or ≤10 wt % relative to the total weight of the fragrance component.

8. The aqueous fabric conditioner composition of claim 1, wherein the fabric conditioner active is present in an amount of ≤25 wt % relative to the total weight of the composition, preferably the fabric conditioner active is a fabric softening agent selected from the group consisting of quaternary ammonium compound (QAC), non-ester quaternary ammonium compound, and mixtures thereof.

9. The aqueous fabric conditioner composition of claim 1, wherein the fabric conditioner active is present in an amount of from 0.01 wt % to 8 wt % relative to the total weight of the composition, and the fragrance component exhibits a perceived intensity, perceived longevity and/or perceived fidelity of a fragrance profile at 24 hours after use by a consumer that is parity with or greater than a perceived intensity, perceived longevity and/or perceived fidelity of a control composition that does not contain the High Performance fragrance ingredients.

10. The aqueous fabric conditioner composition of claim 9, wherein:
the Ultra High-Impact fragrance ingredients are selected from the group consisting of Table 1 ingredients 4, 16, 19, 39, 43, and mixtures thereof; and
the High-Impact fragrance ingredients are selected from the group consisting of Table 2 ingredients 3, 4, 6, 14-16, 20, 21, 23-27, 42, 46, 57, 61, 83, 88-89, 96, and mixtures thereof.

11. The aqueous fabric conditioner composition of claim 1, wherein the aqueous fabric conditioner composition has a stable viscosity of greater than 10 cps, preferably from 20 cps to 350 cps as measured under shear 2 s⁻¹ at 37° C.

12. The aqueous fabric conditioner composition of claim 1, wherein the fabric conditioner active is present in an amount of from 0.01 wt % to 8 wt % relative to the total weight of the composition, and the fragrance component, preferably the High Performance fragrance ingredients, more preferably the Ultra High-Impact fragrance ingredients, exhibits a perceived longevity of a fragrance profile, preferably the fragrance profile derived from top notes and heart notes, at 24 hours after use by a consumer that is parity with or greater than a perceived longevity of a control composition that does not contain the High Performance fragrance ingredients.

13. The fabric conditioner composition of claim 1, wherein the weight of non-biodegradable materials collected from wash water per wash is reduced, preferably substantially reduced, as compared to a control composition that does not contain the High Performance fragrance ingredients, and/or preferably the fragrance component has a bio-renewable carbon (BRC) content of at least 25 wt %, at least 30 wt % or at least 34 wt % relative to the total weight of the fragrance component.

14. The fabric conditioner composition of claim 1, wherein the fragrance component has a bio-renewable carbon (BRC) content of at least 25 wt %, at least 30 wt %, at least 34 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt % or at least 95 wt % relative to the total weight of the fragrance component.

15. Use of an aqueous fabric conditioner composition of claim 1 for imparting or enhancing the perception of a fragrance profile, in particular a fresh character and/or a clean character, by a consumer during use.
